(19) United States
(12) Patent Application Publication
(10) Pub. No.: US 2023/0241595 A1
(43) Pub. Date: Aug. 3, 2023

(54) PROCESS FOR PREPARING CATALYTICALLY ACTIVE SCAFFOLDS

(71) Applicant: Commonwealth Scientific and Industrial Research Organisation, Australian Capital Territory (AU)

(72) Inventors: Yutong ZHU, Acton, Australian Capital Territory (AU); Christian HORNUNG, Acton, Australian Capital Territory (AU); John TSANAKTSIDIDS, Acton, Australian Capital Territory (AU); Xuan NGUYEN, Acton, Australian Capital Territory (AU); Darren FRASER, Acton, Australian Capital Territory (AU)

(21) Appl. No.: 18/004,804

(22) PCT Filed: Jul. 9, 2021
(86) PCT No.: PCT/AU2021/050739

§ 371 Date: Jan. 9, 2023

(30) Foreign Application Priority Data
Jul. 9, 2020 (AU) 2020902374

(51) Int. Cl. B01J 35/04; B01J 35/10; B01J 37/06; B01J 37/18; B01J 23/755

(52) U.S. Cl. CPC B01J 35/04; B01J 35/1061; B01J 35/1066; B01J 35/1071; B01J 35/1009; B01J 35/1014; B01J 35/1019; B01J 35/1023; B01J 35/1038; B01J 35/1042; B01J 35/1047; B01J 37/06; B01J 37/18; B01J 23/755

(57) ABSTRACT

The present disclosure generally relates to a process for preparing a catalytically active scaffold from a scaffold material, and in particular activating a surface of a scaffold by chemically removing sacrificial material from the surface of the scaffold to provide catalytically reactive sites on the surface of the scaffold.

### FIELD

The present disclosure generally relates to a process for preparing a catalytically active scaffold from a scaffold material, and in particular activating a surface of a scaffold by chemically removing sacrificial material from the surface of the scaffold to provide catalytically reactive sites on the surface of the scaffold.

### BACKGROUND

Continuous flow chemical reactors generally comprise a tubular reaction chamber with reactant fluids being continuously fed into the reaction chamber to undergo a chemical reaction to continuously form products which flow out from the reaction chamber. The reaction chambers are typically submerged in a heating/coolant fluid, for example in a shell-and-tube heat exchanger configuration, to facilitate the transfer of heat to/away from the reaction.

Continuous flow reactors used in catalytic reactions typically employ packed bed reaction chambers in which the reaction chamber is packed with solid catalyst particles that provide catalytic surfaces on which the chemical reaction can occur. Static mixers are used for pre-mixing of fluid streams prior to contact with the packed bed reaction chambers and downstream of these chambers to transfer heat between the central and the outer regions of the reactor tubes. The static mixers comprise solid structures that interrupt the fluid flow to promote mixing of the reactants prior to reaction in the packed bed reaction chambers and for promoting desirable patterns of heat transfer downstream of these chambers.

There is a need for alternative or improved processes for preparing catalytically active scaffolds, and in particular scaffolds of static mixers, that can provide various desirable properties such as flexibility and usability of catalytic static mixer technology which are capable of providing more efficient mixing, heat transfer and catalytic reaction of reactant chemical and/or electrochemical reactants.

### SUMMARY

The present inventors have undertaken significant research and development into alternative methods for the preparation of catalytically active scaffolds and have identified that the surface of a scaffold, e.g. a static mixer scaffold, can be provided with a catalytic surface such that the resulting static mixer scaffold is capable of being used with a continuous flow chemical reactor.

In one aspect, there is provided a catalytically active static mixer comprising a scaffold material comprising an active catalyst material and optionally inert material wherein the catalytically active scaffold material is in the form of a lattice of interconnected segments repeated periodically along the longitudinal axis of the scaffold, each segment configured to define a plurality of pores and passages in a non-line-of-sight configuration, wherein the plurality of passages are configured for dispersing and mixing one or more fluidic reactants during flow and reaction thereof, by redistributing the fluid in directions transverse to the flow by changing the localised flow direction or to splitting the flow by more than 200 m⁻¹, corresponding to a number of times within a given length along a longitudinal axis of the catalytically active scaffold material; wherein the plurality of passages is defined by a plurality of pores; wherein the pores comprises one or more sub pores within the pores; wherein the pores are at least about 100 fold larger than the sub pores. The pore size of the one or more pores within the pores is in a range of about 0.1 μm to 500 μm. The catalytically active scaffold material is in the form of a catalytic static mixer or a catalytically active integral porous insert. The catalytically active scaffold material comprising sub-pores within the pores have a surface area that is at least about 30% greater when compared to the surface area of a scaffold without sub-pores. The mass loss of the catalytically active scaffold is in a range between about 0.5 wt. % and 60 wt. % when compared to the total mass of a scaffold without sub-pores.

In an embodiment, the active catalyst material may be selected from the group comprising palladium, platinum, nickel, ruthenium, copper, rhodium, gold, silver, cobalt, iridium, osmium, rhenium, chromium, or mixed metal alloys or metal oxides thereof, zeolites, and metal organic frameworks. For example, the active material may be palladium, platinum, nickel, ruthenium, copper, nickel, cobalt, silver, or mixed metal alloys or metal oxides thereof.

In an embodiment, the scaffold material may be one or more of nickel, titanium, aluminium, tungsten, niobium, molybdenum, steel, stainless steel, copper, cobalt chrome, titanium-based alloys, nickel-based alloys, palladium-based alloys, nickel-aluminium based alloys, platinum-based alloys, ruthenium-based alloys, rhodium-based alloys, gold, platinum, palladium and silver.

In another embodiment, the surface area of the catalytically active scaffold may be in a range of about 0.5 m²/g to 750 m²/g. In some embodiments, the total pore volume of the catalytically active scaffold may be in a range of about 0.2 cm³/g to 10 cm³/g.

In an embodiment, the aspect ratio (L/d) of the catalytically active static mixer is at least 75.

In another aspect, there is provided a process for preparing a catalytically active scaffold from a scaffold material is in the form a lattice of interconnected segments repeated periodically along the longitudinal axis of the scaffold, each segment configured to define a plurality of passages and pores in a non-line-of-sight configuration, wherein the plurality of passages are configured for dispersing and mixing one or more fluidic reactants during flow and reaction thereof, by redistributing the fluid in directions transverse to the flow by changing the localised flow direction or to splitting the flow by more than 200 m⁻¹, corresponding to a number of times within a given length along a longitudinal axis of the static mixer, wherein the scaffold material comprises an active catalyst material and a non-active material, wherein the process comprises the step of: (i) activating a surface of a scaffold material by chemically removing at least about 0.5 wt. % of non-active material from the surface of the scaffold material to provide the catalytically active static mixer with catalytically reactive sites on the surface of the scaffold material and one or more sub pores within the pores of the scaffold material, wherein the surface of the scaffold material may be activated using a selective or non-selective chemical process. In another embodiment, the scaffold material may further comprise an inert material. For example, the selective chemical process may be chemical leaching for removing at least about 0.5 wt. % of sacrificial material from the scaffold material, wherein the sacrificial material is the non-active material. The chemical leaching process may comprise use of a leaching solution. In another example, the non-selective chemical process may be chemical etching for removing at least about 0.5 wt. % of sacrificial material from the scaffold material, wherein the sacrificial material is the active catalyst material, the non-active material, the optional inert material, or a combination thereof. The chemical etching process may comprise use of an etching solution.

In an embodiment, the pores may be at least about 100 fold larger than the sub pores. For example, the pores may be at least about 1000 fold larger than the sub pores.

In an embodiment, the mass loss of sacrificial material from the catalytically active scaffold may be in a range between about 0.5 wt. % and 60 wt. %, based on the total mass of the scaffold material.

In another embodiment, the surface area of the catalytically active static mixer may increase by at least about 30% when compared to the surface area of the scaffold material without sub-pores.

In an embodiment, the active catalyst material may be selected from the group comprising palladium, platinum, nickel, ruthenium, copper, rhodium, gold, silver, cobalt, iridium, osmium, rhenium, chromium, or metal oxides thereof, zeolites, and metal organic frameworks. The non-active material may be selected from the group comprising chromium, titanium, copper, iron, zinc, aluminium, nickel, or metal oxides thereof, and carbon-based materials. The inert material may be selected from the group comprising magnesium, or metal oxides thereof, silicon, silicone, polymers, ceramics, metal oxides.

The scaffold material may be titanium, aluminium, tungsten, niobium, molybdenum, steel, stainless steel, copper, cobalt chrome, titanium-based alloys, nickel-based alloys, palladium-based alloys, nickel-aluminium based alloys, platinum-based alloys, ruthenium-based alloys, rhodium-based alloys, gold, platinum, palladium and silver. For example, the scaffold material may be a nickel-based alloy. In another example, the scaffold material may be nickel metal foam.

In another embodiment, the surface area of the catalytically active static mixer may be in a range of about 0.5 m²/g to 750 m²/g. In another embodiment, the total pore volume of the catalytically active static mixer may be in a range of about 0.2 cm³/g to 10 cm³/g. In yet another embodiment, the pore size of the sub pores may be in a range of about 0.05 μm to 500 μm.

In another embodiment, the process comprises step ii) a further activation step for removing metal oxide impurities by contacting the surface of the catalytically active scaffold with hydrogen gas.

### BRIEF DESCRIPTION OF THE DRAWINGS

Preferred embodiments of the present disclosure will now be further described and illustrated, by way of example only, with reference to the accompanying drawings in which:

FIG. 1 shows general routes for preparing a catalytically active scaffold via (a) a chemical leaching process and (b) a chemical etching process.

FIG. 2 shows scanning electron micrographs (SEM) images of (a) untreated Monel scaffold and (b) treated Monel catalytic static mixer using a chemical leaching process.

FIG. 3 shows scanning electron micrographs (SEM) images of (a) untreated Inconel scaffold and (b) treated Inconel catalytic static mixer using a chemical etching process.

FIG. 4 shows scanning electron micrographs (SEM) images of (a) untreated nickel foam scaffold and (b) treated nickel foam catalytic static mixer using a chemical etching process.

FIG. 5 shows scatter plots (a) and (c) of vinyl acetate conversion against liquid flow rate and (b) against hydrogen to substrate molar ratio (H/S ratio), for the reduction of vinyl acetate in ethanol into ethyl acetate over each set of CSMs. The reactions were conducted at p=20 bar, T=120° C., c(vinyl acetate)=2M for (a) and (b), and 0.5 M for (c), V_{G,N}(H₂)=50 mL_{N}/min for (a) and (b), and V_{G,N}(H₂)=variable for (c).

FIG. 6 shows a scatter plot of coumarin conversion against liquid flow rate, at a constant H/S=5. The liquid and gas flow rates were varied in tandem in order to maintain a constant H/S ratio.

FIG. 7 shows product composition for the hydrogenation of cinnamaldehyde over three sets of CSMs at a liquid flow rate of 2 ml/min and H/S=5.

FIG. 8 shows product composition for the hydrogenation of linalool over two sets of CSMs at a liquid flow rate of 2 ml/min and H/S=5.

FIG. 9 shows conversion of hydrogenation of the 2,5-dichloronitrobenzene over two sets of CSMs at a liquid flow rate of 2 mL/min and H/S=5.

### DETAILED DESCRIPTION

The present disclosure describes the following various non-limiting embodiments, which relate to investigations undertaken to identify alternative or improved processes for preparing catalytically active scaffolds of static mixers (CSMs) that can provide various desirable properties such as flexibility and usability of catalytic static mixer technology which are capable of providing more efficient mixing, heat transfer and catalytic reaction of reactant chemical and/or electrochemical reactants. It was surprisingly found that chemically removing sacrificial material from the surface of a scaffold, for example, the surface of scaffolds, e.g. static mixers, can provide efficient mixing, heat transfer and catalytic reaction of reactants in continuous flow chemical reactors. It will be appreciated that the techniques described by the present invention may depend on the application and the type of catalyst and/or scaffold employed. The inventors have also surprisingly identified that chemically removing sacrificial material from the surface of a scaffold, as described herein, provides an improved technique for catalytically activating complex three-dimensional structures, such as static mixer scaffolds.

Compared to current heterogeneous catalysis systems, such as packed beds, the present static mixers have been shown to provide various advantages. While static mixers enable flexibility in re-design and configuration of the static mixers, they present other difficulties and challenges in providing robust commercially viable scaffolds that can be catalytically activated to operate under certain operational performance parameters of continuous flow chemical reactors, such as to provide desirable mixing and flow conditions inside the continuous flow reactor, and enhanced heat and mass transfer characteristics and reduced back pressures compared to packed bed systems.

Chemically removing sacrificial material from the surface of a scaffold by a selective or non-selective chemical processes has been found to be surprisingly suitable for catalytically activating the surface of the scaffold, e.g. static mixer scaffold, and suitable for application with a wide variety of scaffold materials.

For example, static mixer scaffolds can be configured as scaffolds to provide inserts for use with in-line continuous flow reactor systems. The static mixer scaffolds can also provide heterogeneous catalysis, which is of significant importance to chemical manufacturing and is broad ranging including the production of fine and specialty chemicals, pharmaceuticals, food and agrochemicals, consumer products, and petrochemicals.

### General Terms

Throughout this specification, unless specifically stated otherwise or the context requires otherwise, reference to a single step, composition of matter, group of steps or group of compositions of matter shall be taken to encompass one and a plurality (i.e. one or more) of those steps, compositions of matter, groups of steps or groups of compositions of matter. Thus, as used herein, the singular forms “a”, “an” and “the” include plural aspects unless the context clearly dictates otherwise. For example, reference to “a” includes a single as well as two or more; reference to “an” includes a single as well as two or more; reference to “the” includes a single as well as two or more and so forth.

Those skilled in the art will appreciate that the disclosure herein is susceptible to variations and modifications other than those specifically described. It is to be understood that the disclosure includes all such variations and modifications. The disclosure also includes all of the steps, features, compositions and compounds referred to or indicated in this specification, individually or collectively, and any and all combinations or any two or more of said steps or features.

Each example of the present disclosure described herein is to be applied mutatis mutandis to each and every other example unless specifically stated otherwise. The present disclosure is not to be limited in scope by the specific examples described herein, which are intended for the purpose of exemplification only. Functionally-equivalent products, compositions and methods are clearly within the scope of the disclosure as described herein.

The term “and/or”, e.g., “X and/or Y” shall be understood to mean either “X and Y” or “X or Y” and shall be taken to provide explicit support for both meanings or for either meaning.

Throughout this specification the word “comprise”, or variations such as “comprises” or “comprising”, will be understood to imply the inclusion of a stated scaffold, integer or step, or group of scaffolds, integers or steps, but not the exclusion of any other scaffold, integer or step, or group of scaffolds, integers or steps.

### Specific Terms

The term “catalytically active static mixer” shall be understood to mean a catalytically active scaffold prepared from scaffold material comprising active catalyst material and non-active material.

The term “active catalyst material” shall be understood to mean the material which can provide catalytic activity.

The term “non-active material” may optionally comprise inert material. It shall be understood that the non-active material may be either fully or partially sacrificed during the substrative manufacturing process described herein.

The term “sacrificed component” or “sacrificed material” or “sacrificial material” shall be understood to mean material (at least a portion thereof) that is selectively or non-selectively removed from the surface of the static mixer scaffold. In chemical etching (non-selective) process, the sacrificial material, as defined herein may be either (1) active catalyst material or (2) a combination of active catalyst material and non-active material. In chemical leaching (selective) process, the sacrificial material, as defined herein, may be non-active material.

The term “inert material” consists of material that is not catalytically active and does not participate as active catalyst material. It shall be understood that inert material, as defined herein, may or may not be dissolved during the substrative manufacturing process (i.e. chemical leaching or chemical etching process). In other words, the inert material can be dissolved during chemical etching or chemical leaching. Alternatively, the inert material can remain undissolved during chemical etching or chemical leaching but are defined as material that are non-catalytic and optionally present.

It will be clearly understood that, although a number of prior art publications are referred to herein, this reference does not constitute an admission that any of these documents forms part of the common general knowledge in the art, in Australia or in any other country.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the present specification, including definitions, will control. In addition, the materials, methods, and examples are illustrative only and not intended to be limiting.

### Process for Preparing Catalytically Active Scaffolds

The inventors have discovered an effective and scalable method for the preparation of catalytically active scaffolds (e.g. catalytically active static mixers) for use within continuous flow reactors in heterogeneous catalysis applications.

The inventors have surprisingly identified that by using a subtractive manufacturing method like chemical etching or leaching and removing at least a portion of non-active material from a preformed scaffold (e.g. static mixer scaffold) comprising a combination of active and non-active material, a catalytically active scaffold (e.g. catalytic static mixers, CSMs) can be formed. An additive manufacturing process (3D printing) can be used to form a static mixer which has a non-line-of-sight configuration comprising a plurality of passages defined by a plurality of pores. By activating the surface of the scaffold using either chemical etching or leaching methods, sub pores are created within the pores resulting in a catalytic static mixer which has a non-line-of-sight configuration comprising a plurality of passages configured for dispersing and mixing one or more fluidic reactants during flow and reaction thereof, by redistributing the fluid in directions transverse to the flow by changing the localised flow direction or to splitting the flow by more than 200 m⁻¹, corresponding to a number of times within a given length along a longitudinal axis of the static mixer, where the plurality of passages is defined by a plurality of pores and the pores comprises one or more sub pores within the pores. The pores of the catalytic static mixer are at least about 100 fold larger than the sub pores.

It has been surprisingly found that the surface area of the scaffold increases as a result of the chemical leaching or etching processes providing the surface of the catalytically active scaffold or catalytically active static mixer scaffold with increased surface activity such that more active material may be exposed to the environment, for example, exposed to one or more fluidic reactants during flow and reaction thereof.

It will be appreciated that the static mixer, as described herein, may be prepared from scaffold material comprising active catalyst material and non-active material. Non-active material may optionally comprise inert material. Non-active material is either fully or partially sacrificed during the substrative manufacturing process. The sacrificed component may be referred to as sacrificial material. Inert material consists of material that is not catalytically active and does not participate as active catalyst material. Inert material may or may not be dissolved during the substrative manufacturing process.

The catalytically active static mixer, once formed, comprises active catalyst material and optionally inert material. Depending on the amount of non-active material sacrificed, the catalytically active static mixer may also comprise non-active material.

The active catalyst material can be oxidised to form metal oxides on the surface of the catalytically active static mixer. The catalytically active static mixer can be reactivated by hydrogenation of the metal oxides that form.

The resulting catalytically active scaffold or catalytically active static mixer scaffold possesses a) tailored mixing characteristics as a result of the design created by 3D printing or other manufacturing process and b) a high active surface area, containing the catalytically active metals, such as nickel, as a result of the etching/leaching process.

It will be appreciated that if the scaffold formed is not catalytically active or if the catalytic activity is low, the subtractive method of chemically etching or leaching out a sacrificial material can then facilitate formation of a catalytically active scaffold or catalytically active static mixer scaffold having high porosity and surface area, leading to effective catalytic activity. It will be understood that the process described herein is instrumental for the performance of the catalytically active scaffold or catalytically active static mixer scaffold in chemical synthesis. For example, the catalytically active static mixer scaffold can be used for a range of suitable heterogeneous catalytic applications, such as hydrogenations, oxidations and others, within a tubular or ducted reactor system.

Chemical Leaching

It will be appreciated from the present disclosure that static mixers subjected to chemical leaching comprise an active catalyst material, and a non-active catalyst material that is sacrificed during the chemical leaching process, and optionally an inert material. Chemical leaching can selectively remove at least a portion of the non-active material (sacrificial material) from the surface of the static mixer scaffold, leaving behind the active catalyst material. It is to be understood that the inert material may or may not be dissolved depending on the conditions used. The resulting surface of the catalytically active static mixer scaffold comprises sub-pores within the pores that are catalytically active. For example, chemical leaching may remove a sacrificial metal phase selectively, by dissolving the sacrificial metal phase (i.e. the non-active material) from a printed alloy matrix, while leaving the ‘desired’, catalytically active metal species (e.g. active catalyst material, nickel), intact and in place. In a particular example, selective removal of copper from Monel (nickel based alloy scaffold material) in higher amounts than nickel may apply during the chemical leaching process, as described herein. It will be appreciated that nickel and copper are the two main components of Monel by weight. The resulting leached material (i.e. catalytically active static mixer) may be porous, enriched in nickel, and depleted in copper.

In some embodiments or examples, the selective chemical process may be a chemical leaching process for removing sacrificial material. It will be appreciated that the sacrificial material in the chemical leaching process may be the selective removal of a non-active material present in the scaffold material. The selective enrichment of the active catalyst species will be at least 2 fold compared to the sacrificial material.

In an embodiment, the selective chemical process may be chemical leaching for removing at least about 0.5 wt. %, of sacrificial material from the scaffold material, wherein the sacrificial material is the non-active material.

In some embodiments or examples, the mass loss (by weight %) of sacrificial material in the scaffold material may be in a range of between about 0.5 wt. % and about 60 wt. %. For example, the mass loss (by weight %) may be in a range of between about 0.5 wt. % and about 40 wt. %. The mass loss (by weight %) of sacrificial material may be less than about 60, 55, 50, 45, 40, 35, 30, 25, 20, 15, 10, 5, 1, or 0.5. The mass loss (by weight %) of sacrificial material may be at least about 0.5, 1, 10, 20, 30, 40, 50, or 60. The mass ratio (by weight %) of sacrificial material in the starting scaffold material may be a range provided by any two of these upper and/or lower values.

The chemical leaching process may comprise the step of subjecting the scaffold as described herein to a leaching solution as described herein to provide a catalytically active scaffold or catalytically active static mixer scaffold comprising sub-pores within the pores that define the plurality of passages.

### Chemical Etching

It will be appreciated from the present disclosure that static mixers subjected to chemical etching comprise of active catalyst material and non-active catalyst material which are same or different and optionally an inert material. The chemical etching process can non-selectively remove several species from the surface of the scaffold by dissolving them from the surface. In some embodiments or examples the active catalyst material and the non-active material are the same, meaning they are made from a single active catalyst material, chemical etching will result in a catalytically active static mixer prepared from an active catalyst material. In this instance, the sacrificial material will be the active catalyst material. Such a static mixer may or may not contain inert material. The etching process may sacrifice both the active catalyst material and the inert material. In another example, the active catalyst material and the non-active material are different, chemical etching will result in catalytically active static mixer prepared from non-selective removal of both the non-active and active materials. In this instance, the sacrificial material comprises both active and non-active materials. Such a static mixer may or may not contain inert material. The etching process may dissolve both the active catalyst material and the inert material. The resulting surface of the scaffold in both examples, comprises catalytically active material. The surface of the catalytically active static mixer scaffold will contain sub-pores within the pores that define the plurality of passages. In one example, the non-selective removal of nickel and chromium from Inconel (nickel-chromium based alloy scaffold material), which are the two main components of Inconel by weight. The resulting etched layer may be porous, but not significantly enriched in nickel or chromium. In another example, nickel foam or other scaffold material comprising of only one metal element (with negligible amount of impurities), the etching process, as described herein, may dissolve the surface layer of the scaffold and provide a highly porous surface that is catalytically active.

It will be appreciated that the sacrificial material in the chemical etching process may be the non-selective removal of a non-active material and/or active catalyst material present in the scaffold material.

In an embodiment, the non-selective chemical process may be chemical etching for removing at least about 0.5 wt. % of sacrificial material from the scaffold material, wherein the sacrificial material is the active catalyst material, the non-active material, the optional inert material, or a combination thereof.

In some embodiments or examples, the mass loss (by weight %) of sacrificial material in the scaffold material may be in a range of between about 0.5 wt. % and about 60 wt. %. For example, the mass loss (by weight %) may be in a range of between about 0.5 wt. % and about 40 wt. %. The mass loss (by weight %) of sacrificial material may be less than about 60, 55, 50, 45, 40, 35, 30, 25, 20, 15, 10, 5, 1, or 0.5. The mass loss (by weight %) of sacrificial material may be at least about 0.5, 1, 10, 20, 30, 40, 50, or 60. The mass ratio (by weight %) of sacrificial material in the starting scaffold material may be a range provided by any two of these upper and/or lower values.

The chemical etching process may comprise the step of subjecting the scaffold as described herein to an etching solution as described herein to provide a catalytically active scaffold or catalytically active static mixer scaffold.

### Further Activation

Once the catalytically active static mixers are formed using the subtractive processes mentioned herein, the active catalyst material can be further activated by contacting the surface of the catalytically active static mixer with hydrogen gas to remove metal oxides that form on the surface of the catalytically active static mixer.

### Chemical Leaching and Etching Solutions

In some embodiments or examples, the chemical leaching process may comprise use of a leaching solution. In some embodiments or examples, the chemical etching process may comprise use of an etching solution.

For example, the leaching solution and etching solution may be selected from an acidic, basic, oxidising, or any other known leaching/etching solutions known in the art. It will be appreciated that the leaching and etching solutions may be selected based on the type of scaffold material used.

For example, the basic solution may comprise persulfate salt and ammonia in a highly alkaline aqueous solution. It will be appreciated that a strong base activates persulfate ions providing in situ generation of highly reactive oxygen molecules. It will be appreciated that the basic solution may comprise one of more bases. In an example, the basic solution may be selected from potassium persulfate, sodium persulfate, ammonium persulfate, potassium sulfate, sodium sulfate, ammonium sulfate, sodium hydroxide, potassium hydroxide, ammonium hydroxide, calcium hydroxide, magnesium hydroxide, barium hydroxide, aluminium hydroxide, caesium hydroxide, strontium hydroxide, lithium hydroxide, rubidium hydroxide, or combinations thereof. For example, the basic solution may be selected from potassium persulfate, sodium persulfate, ammonium persulfate, potassium sulfate, sodium sulfate, ammonium sulfate, or combinations thereof.

It will be appreciated that the acidic solution may comprise one of more acids. In an example, the acidic solution may be selected from, but are not limited to: ASTM No. 30, Adler Etchant, Kalling's No. 2, Kellers Etch, Klemm's Reagent, Kroll's Reagent, Nital, Marble's Reagent, Murakami's, Picral, Vilella's Reagent, Jewitt-Wise etch, hydrochloric acid, sulfuric acid, phosphoric acid, nitric acid, aqua regia, ferric chloride, acetic acid, hydrofluoric acid, ceric ammonium nitrate, hydrobromic acid, chromic acid, or combinations thereof. For example, the acidic solution may be selected from, but not limited to, ASTM No. 30, Adler Etchant, Nital, Marble's Reagent, hydrochloric acid, sulfuric acid, phosphoric acid, nitric acid, ferric chloride, or combinations thereof.

It will be appreciated for or oxidative dissolution of species from the surface of the scaffold material, the leaching or etching solution may contain at least one oxidizing agent (to oxidize the species), an optional solvent (water or a non-aqueous solvent) to dissolve the oxidizing agent, and an optional complexing agent to adjust the redox potential of the species and/or the solubility of the species produces. In an example, the oxidising agent may be selected from, but are not limited to: dissolved oxygen, hydrogen peroxide (H₂O₂), free chlorine, potassium chromate (K₂Cr₂O₇), potassium permanganate (KMnO₄), or combinations thereof.

### Composition of Catalytically Active Scaffolds

In some embodiments, there is provided catalytically active static mixer comprising a scaffold material comprising an active catalyst material, and optional an inert material; wherein the scaffold material is in the form of a lattice of interconnected segments repeated periodically along the longitudinal axis of the scaffold, each segment configured to define a plurality of passages and pores in a non-line-of-sight configuration, wherein the plurality of passages are configured for dispersing and mixing one or more fluidic reactants during flow and reaction thereof, by redistributing the fluid in directions transverse to the flow by changing the localised flow direction or to splitting the flow by more than 200 m⁻¹, corresponding to a number of times within a given length along a longitudinal axis of the catalytically active static mixer; wherein the plurality of passages is defined by a plurality of pores; wherein the pores comprises one or more sub pores within the pores; and wherein the pores are at least about 100 fold larger than the sub pores. The pore size of the one or more pores within the pores may be in a range of about 0.1 μm to 500 μm.

In some other embodiments or examples, there is provided process for preparing a catalytically active static mixer from a scaffold material which is in the form of a lattice of interconnected segments repeated periodically along the longitudinal axis of the scaffold, each segment configured to define a plurality of passages and pores in a non-line-of-sight configuration, wherein the plurality of passages are configured for dispersing and mixing one or more fluidic reactants during flow and reaction thereof, by redistributing the fluid in directions transverse to the flow by changing the localised flow direction or to splitting the flow by more than 200 m⁻¹, corresponding to a number of times within a given length along a longitudinal axis of the static mixer, wherein the plurality of passages is defined by a plurality of pores, wherein the scaffold material comprises an active catalyst material and a non-active material, wherein the process comprises the step of: (i) activating a surface of a scaffold material by chemically removing at least about 0.5 wt. % of non-active material from the surface of the scaffold material to provide the catalytically active static mixer with catalytically reactive sites on the scaffold material, wherein the scaffold material is activated using a selective or non-selective chemical process, wherein the activation step results in catalytically active sub pores within the pores of the scaffold material. The activation step is described herein as a subtractive manufacturing process such as chemical leaching or chemical etching.

In some embodiments or examples, it will be appreciated that there may be overlap between the active catalyst materials, non-active materials and inert materials.

### Active Catalyst Material

It will be appreciated that the active catalyst material as described herein may provide the surface of the scaffold with catalytic activity. The active catalyst material may be selected from the group comprising palladium, platinum, nickel, ruthenium, copper, rhodium, gold, silver, cobalt, iridium, osmium, rhenium, chromium, or mixed metal alloys or metal oxides thereof, zeolites, and metal organic frameworks. For example, the active catalyst material may be palladium, platinum, nickel, ruthenium, copper, nickel, cobalt, silver, or mixed metal alloys or metal oxides thereof.

It will be appreciated that zeolites are hydrated aluminosilicate minerals made from interlinked tetrahedra of alumina (AlO₄) and silica (SiO₄). The structure of a zeolite can be a three-dimensional crystal structure built from the elements aluminium, oxygen, and silicon, with alkali or alkaline-earth metals (e.g. sodium, potassium, and magnesium) and water molecules trapped in the gaps between them. Zeolites form with many different crystalline structures having open pores in regular arrangement.

It will be appreciated that MOFs are one-, two- or three-dimensional structures provided by an organometallic polymeric framework comprising a plurality of metal ions or metal clusters each coordinated to one or more organic ligands. MOFs may provide porous structures comprising a plurality of pores. The MOFs may be crystalline or amorphous, for example it will be appreciated that one-, two- or three-dimensional MOF structures may be amorphous or crystalline.

### Non-Active Material

It will be appreciated that the non-active material as described herein may dissolve from the surface of the scaffold into the chemical leaching or chemical etching solutions. In some embodiments or examples, it will be appreciated that there may be some overlap between the active catalyst material and non-active material. For example, the active catalyst material may be a sacrificial material, i.e. during a non-selective chemical etching process it will be appreciated that both active catalyst material and non-active material may be dissolved from the surface of the scaffold material.

The non-active material may be selected from the group comprising chromium, titanium, copper, iron, zinc, aluminium, nickel, silver, or metal oxides thereof, polymers, and carbon.

Examples of polymers which can be used include, but are not limited to: polycarbonate, polymethylmethacrylate, polypropylene, polyethylene, polyamide, polyacrylamide, polyvinylchloride or copolymers or any combinations thereof.

Examples of carbon-based materials which can be used include, but are not limited to: carbon nanotubes, carbon nanofibers, graphene nanosheets, graphene quantum dots, graphene nanoribbons, graphene nanoparticles, and derivatives thereof.

### Inert Material

It will be appreciated that the inert material as described here denote material that may be present in the scaffold material but will not be required or used as catalytically active material in a catalytically active static mixer. Inert material when present can be subjected at least in part to chemical etching or leaching. The inert material may also be resistant to corrosion and oxidation in moist air. The inert material may have minimal chemical reactivity when the catalytic static mixer is used for a catalytic reaction. It will be appreciated that the inert material may remain intact when the scaffold is subjected to the chemical processes as described herein.

In some embodiments or example, the inert material may be selected from the group comprising aluminium, iron, copper, zinc, chromium, titanium, magnesium, silver, metal oxides thereof, silicon, silicone, polymers, ceramics, zeolites, metal organic frameworks.

Examples of polymers which can be used include, but are not limited to: polycarbonate, polymethylmethacrylate, polypropylene, polyethylene, polyamide, polyacrylamide, polyvinylchloride or copolymers or any combinations thereof. In some embodiments or examples, any polyester (including poly(alpha-hydroxy esters), polyethers (including polyethylene oxide), polystyrene and polymethylmethacrylate can be used for the formation of the scaffold. In other embodiments or examples, thermoplastics can be used for the formation of the scaffold. In yet another embodiment, non-biodegradable and biodegradable polymers are contemplated for formation of the scaffold.

### Surface Characterisation of the Scaffold Material and the Catalytically Active Scaffold

The catalytically active static mixers, and the process for producing the catalytically active static mixers, described herein have shown to advantageously improve the catalytic activity and increase the surface area of the catalytically active scaffolds or catalytically active static mixer scaffolds.

In some embodiments or examples, the mass ratio (by weight %) of sacrificial material to active material in the starting scaffold material may be in a range of about 1:100 to 50:1. The ratio of sacrificial material may be less than about 50, 45, 40, 35, 30, 25, 20, 15, 10, 5, or 1. The ratio of active material may be at least 1, 10, 20, 30, 40, 50, 60, 70, 80, 90 or 100. The mass ratio (by weight %) of sacrificial material to active material in the starting scaffold material may be a range provided by any two of these upper and/or lower values.

In some embodiments or examples, the mass loss ratio (by weight %) in the catalytically active scaffold may provide a sacrificial material to active material in a range of about 20:80 to 80:20. The range of sacrificial material may be less than about 80, 70, 60, 50, 40, 30, 20, or 10. The range of active material may be at least 10, 15, 20, 25, 30, 35, 40, 45, 50, 55, 60, 65, 70, 75, 80, or 85. The mass loss ratio (by weight %) in the catalytically active scaffold may be a range provided by any two of these upper and/or lower values.

In some embodiments or example, the surface of the starting scaffold material may comprise at least about 30% (by weight) of an active material selected from a catalytically active metal. It will be appreciated that the catalytically active metal may selected from any one of the active materials described herein. The surface of the scaffold material may comprise at least about 30%, 40%, 50%, 60%, 70% or 80% (by weight) of the active material. The surface of the scaffold material may comprise less than about 95%, 85%, 75%, 65%, 55%, 45%, or 35% (by weight) of the active material. The surface of the scaffold material may comprise a % by weight of active material in a range provided by any two of these upper and/or lower values.

In some embodiments, or examples, the mass loss of the catalytically active scaffold (e.g. static mixer) may be in a range between about 0.5 wt. % and 60 wt. % when compared to the total mass of the scaffold material without sub-pores. For example, the mass loss of the catalytically active scaffold (e.g. static mixer) may be in a range between about 0.5 wt. % and 40 wt. % when compared to the total mass of the scaffold material without sub-pores.

When the scaffold material is subjected to a chemical leaching process, as described herein, the mass loss of the catalytically active scaffold (e.g. static mixer) may be in a range between about 0.5 wt. % and 60 wt. % when compared to the total mass of the scaffold material without sub-pores. For example, the mass loss (by weight %) may be in a range of between about 0.5 wt. % and about 40 wt. %. For example, the mass loss (by weight %) of sacrificial material may be less than about 60, 55, 50, 45, 40, 35, 30, 25, 20, 15, 10, 5, 1, or 0.5. The mass loss (by weight %) of sacrificial material may be at least about 0.5, 1, 5, 10, 20, 30, 40, 50, or 60. The mass ratio (by weight %) of sacrificial material in the starting scaffold material may be a range provided by any two of these upper and/or lower values.

When the scaffold material is subjected to a chemical etching process, as described herein, the mass loss of the catalytically active scaffold (e.g. static mixer) may be in a range between about 0.5 wt. % and 60 wt. % when compared to the total mass of the scaffold material without sub-pores. For example, the mass loss (by weight %) may be in a range of between about 0.5 wt. % and about 40 wt. %. For example, the mass loss (by weight %) of sacrificial material may be less than about 60, 55, 50, 45, 40, 35, 30, 25, 20, 15, 10, 5, 1, or 0.5. The mass loss (by weight %) of sacrificial material may be at least about 0.5, 1, 5, 10, 20, 30, 40, 50, or 60. The mass ratio (by weight %) of sacrificial material in the starting scaffold material may be a range provided by any two of these upper and/or lower values.

The chemical etching process may comprise the step of subjecting the scaffold as described herein to an etching solution as described herein to provide a catalytically active scaffold or catalytically active static mixer scaffold.

In some embodiments or examples, the surface area of the catalytically active scaffold (e.g. static mixer) may be at least about 30% greater when compared to the surface area of the scaffold material without sub-pores.

In some embodiments or examples, the surface area of the catalytically active scaffold (e.g. static mixer) may be in a range of about 0.5 m²/g to 750 m²/g. The surface area (m²/g) may be less than about 750, 700, 650, 600, 550, 500, 450, 400, 350, 300, 250, 200, 150, 100, 50, 25, 10, 5, or 1. The surface area (m²/g) may be at least about 0.5, 1, 5, 10, 20, 40, 50, 80, 100, 150, 200, 250, 300, 350, 400, 450, 500, 550, 600, 650, or 700. The surface area of the catalytically active scaffold may be a range provided by any two of these upper and/or lower values.

In some embodiments or examples, the total pore volume of the catalytically active scaffold (e.g. static mixer) may be in a range of about 0.2 cm³/g to 10 cm³/g. The total pore volume (cm³/g) may less than about 10, 9, 8, 7, 6, 5, 4, 3, 2, 1, 0.5 or 0.2. The total pore volume (cm³/g) may be at least about 0.2, 0.5, 1, 2, 3, 4, 5, 6, 7, 8, 9 or 10. The total pore volume of the catalytically active scaffold (may be a range provided by any two of these upper and/or lower values.

The inventors have surprising found that the catalytically active static mixers as described herein comprise one or more sub pores within the pores. In an embodiment, the pores may be at least about 100 fold larger than the sub pores. For example, the pores may be at least about 1000 fold larger than the sub pores. For example, the scaffold material comprises a plurality of passages which can be defined as pores, these pores may have a pore size in the range of between about 1 mm to about 10 mm. It has unexpectedly be found that sub pores can be provided within the pores by the chemical leaching/etching process, as defined herein.

In some embodiments or examples, the pore size of the one or more pores within the pores is in a range of about 0.05 μm to 500 μm. For example, the pore size of the sub pores may be in a range of about 0.05 μm to 500 μm. The pore size (μm) may be less than 500, 450, 400, 350, 300, 250, 200, 150, 100, 75, 50, 25, 10, 5, 1, 0.5, 0.1, or 0.05. The pore size (μm) may be at least 0.05, 0.1, 0.5, 1, 2, 5, 7, 10, 20, 50, 70, 100, 150, 200, 250, 300, 350, 400, 450 or 500. The pore size of the sub pores may be a range provided by any two of these upper and/or lower values.

### Scaffolds and Scaffold Materials

In an embodiment or example, the scaffold may be applied to any device or apparatus. In another embodiment or example, the scaffold may be a complex 3D structure. The complex 3D structure may be porous. In an embodiment or example, the scaffold may be suitable for continuous flow processes. In an embodiment or example, the scaffold may be a static mixer, or an integral porous insert In an embodiment or example, the scaffold may be a static mixer.

The static mixer scaffold may be prepared from scaffold material. The scaffold material is in the form of a lattice of interconnected segments repeated periodically along the longitudinal axis of the scaffold, each segment configured to define a plurality of passages and pores in a non-line-of-sight configuration. The plurality of passages are configured for dispersing and mixing one or more fluidic reactants during flow of reactants or during mixing. The scaffold material may comprise or consist of at least one of a metal, metal alloy, cermet, calcium phosphate or polymer, carbon-based material, or silicon carbide. The scaffold material may be formed from metals, metal alloys, or other known printable polymer-metal composites. For example, the metal or metal alloy may be titanium, nickel, aluminium, tungsten, niobium, molybdenum, steel, stainless steel, copper, cobalt chrome, titanium-based alloys, nickel-based alloys, palladium-based alloys, nickel-aluminium based alloys, platinum-based alloys, ruthenium-based alloys, rhodium-based alloys, gold, platinum, palladium and silver. In another example, the metal or metal oxide may be nickel-based alloys, palladium-based alloys, and nickel-aluminium based alloys. In another example, the metal may be nickel-based alloys. Examples of polymers which can be used include, but are not limited to: polycarbonate, polymethylmethacrylate, polypropylene, polyethylene, polyether ether ketone, polyethylene terephthalate, polylactic acid, polyolefin, polyamide, polyimide, polyacrylamide, polyvinylchloride or copolymers or any combinations thereof. Examples of carbon-based materials which can be used include, but are not limited to: carbon nanotubes, carbon nanofibers, graphene nanosheets, graphene quantum dots, graphene nanoribbons, graphene nanoparticles, and derivatives thereof.

The scaffold material may comprise an active catalyst material, a non-active material, and optionally an inert material, as described herein.

The scaffold material may be prepared from a material suitable for additive manufacturing (i.e. 3D printing). The scaffold material may be prepared from a material suitable for further surface modification to provide or enhance catalytic reactivity, for example a metal including nickel, titanium, palladium, platinum, gold, copper, aluminium or their alloys and others, including metal alloys such as stainless steel. In one embodiment the scaffold material may comprise or consist of titanium, stainless steel, and an alloy of cobalt and chromium. In another embodiment, the scaffold material may comprise or consist of titanium, aluminium or stainless steel. In another embodiment, the scaffold material may comprise or consist of stainless steel and cobalt chromium alloy. In another embodiment, the scaffold material may comprise or consist nickel-based alloys, palladium-based alloys, nickel-aluminium based alloys. Using additive manufacturing techniques, i.e. 3D metal printing, the scaffold material can be specifically designed to perform two major tasks: a) to act as a catalytic material or a substrate for a catalytic material, and b) to act as a flow guide for optimal mixing performance during the chemical reaction and subsequently assist transfer of exothermic heat to the walls of the reactor tube (single phase liquid stream or multiphase stream) inside the reactor.

In one embodiment, the scaffold material comprises a catalytically active surface. In another embodiment, the scaffold material comprises titanium, nickel, aluminium, stainless steel, cobalt, chromium, any alloy thereof, or any combination thereof. Further advantages may be provided wherein the scaffold material comprises or consists of nickel or nickel-based alloys.

The static mixer is for use in a continuous flow chemical reaction system and process. The process may be an in-line continuous flow process. The in-line continuous flow process may be a recycle loop or a single pass process. In one embodiment, the in-line continuous flow process is a single pass process.

As mentioned above, the chemical reactor comprising the static mixer scaffold is capable of performing heterogeneous catalysis reactions in a continuous fashion. The chemical reactor may use single or multi-phase feed and product streams. In one embodiment, the substrate feed (comprising one or more reactants) may be provided as a continuous fluidic stream, for example a liquid stream containing either: a) the substrate as a solute within an appropriate solvent, or b) a liquid substrate, with or without a co-solvent. It will be appreciated that the fluidic stream may be provided by one or more gaseous streams, for example a hydrogen gas or source thereof. The substrate feed is pumped into the reactor using pressure driven flow, e.g. by means of a piston pump.

The volume displacement % of the static mixer relative to a reactor chamber for containing the mixer is in the range of 1 to 60, 2 to 50, 3 to 40, 4 to 22, 5 to 15, or 40 to 60. The volume displacement % of the static mixer relative to a reactor chamber for containing the mixer may be less than 60%, 50%, 40%, 35%, 30%, 25%, 20%, 15%, 10%, or 5%.

The configurations of the static mixers may be provided to enhance cross-sectional microscopic turbulence. Such turbulence may result from various sources, including the geometry of CSM or the microscopic roughness of the CSM surface resulting from the 3D printing process. For example, turbulent length scales may be reduced to provide better mixing. The turbulent length scales may, for example, be in the microscopic length scales.

The configurations of the static mixers may be provided to enhance heat transfer properties in the reactor, for example a reduced temperature differential at the exit cross-section. The heat transfer of the CSM may, for example, provide a cross-sectional or transverse temperature profile that has a temperature differential of less than about 20° C./mm, 15° C./mm, 10° C./mm, 9° C./mm, 8° C./mm, 7° C./mm, 6° C./mm, 5° C./mm, 4° C./mm, 3° C./mm, 2° C./mm, or 1° C./mm.

The scaffold may be configured such that, in use, the pressure drop (or back pressure) across the static mixers (in Pa/m) is in a range of about 0.1 to 1,000,000 Pa/m (or 1 MPa/m), including at any value or range of any values therebetween. For example, the pressure drop (or back pressure) across the static mixer (in Pa/m) may be less than about 500,000, 250,000, 100,000, 50,000, 10,000, 5,000, 1,000, 750, 500, 250, 100, 75, 50, 25, 20, 15, 10, or 5 Pa/m. The static mixers may be configured to provide a lower pressure drop relative to a specific flow rate. In this regard, the static mixers, reactor, system, and processes, as described herein, may be provided with parameters suitable for industrial application. The above pressure drops may be maintained where the volumetric flow rate is at least 0.1, 0.5, 1, 1.5, 2, 2.5, 3, 3.5, 4, 4.5, 5, 6, 7, 8, 9, 10, 20, 30, 40, 50, 100, 500, 1000 ml/min.

The catalytically active scaffold or catalytically active static mixer scaffold may require a chemical or physical (heating) activation process step, for example for hydrogenations activating by exposure of the catalytically active scaffold or catalytically active static mixer scaffold to molecular hydrogen or a source of hydrogen. In some embodiments or example, the process described herein for preparing the catalytically active scaffold or catalytically active static mixer scaffold may comprise step ii) a further activation step for removing metal oxide impurities by contacting the surface of the catalytically active scaffold with hydrogen gas. In some embodiments or examples, the catalytically active scaffold or catalytically active static mixer scaffold may be activated, for example by contacting with an activating fluid (e.g. hydrogen gas) at a temperature ramp from 20° C. to 800° C. for at least 1, 2, 5, 10, 15, 20, 25 or 30 hours. The activation may occur for less than 30, 25, 20, 15, 10, 5, 2, or 1 hours. The activation may occur between a range of any two of the above time values.

The catalytic reactions may be hydrogen insertion reactions that involve the use of hydrogenation catalysts. A hydrogen insertion or hydrogenation catalyst facilitate the insertion of hydrogen into intramolecular bonds of a reactant, e.g., a carbon-oxygen bond to form the oxygen containing organic materials described above, conversion of unsaturated bonds to saturated bonds, removal of protection groups such as converting O-benzyl groups to hydroxyl groups, or reaction of a nitrogen triple bond to form ammonia or hydrazine or mixtures thereof. The hydrogen insertion or hydrogenation catalyst may be chosen from the group consisting of cobalt, ruthenium, osmium, nickel, palladium, platinum, and alloys, compounds and mixtures thereof. In an embodiment, the hydrogen insertion or hydrogenation catalyst comprises or consists of platinum or titanium. In ammonia synthesis the catalyst may facilitate the dissociative adsorption of a hydrogen species source and a nitrogen species source for subsequent reaction. In a further embodiment, the hydrogen insertion or hydrogenation catalyst is activated by leaching or etching.

It will be appreciated that the static mixers can provide an integral scaffold for a chemical reactor chamber. The static mixer scaffold for a continuous flow chemical reactor chamber may comprise a catalytically active scaffold defining a plurality of passages configured for dispersing and mixing one or more fluidic reactants during flow and reaction thereof through the mixer. It will be appreciated that at least a substantial part of the surface of the scaffold may comprise catalytically reactive sites. The catalytically active scaffold or catalytically active static mixer scaffold may be prepared by activating the surface of the scaffold by chemically removing sacrificial material from the surface of the scaffold to provide catalytically reactive sites on the surface of the scaffold.

The static mixer may be provided as one or more scaffolds each configured for inserting into a continuous flow chemical reactor or reactor chamber thereof. The static mixer scaffold may be configured as a modular insert for assembly into a continuous flow chemical reactor or chamber thereof. The static mixer scaffold may be configured as an insert for an in-line continuous flow chemical reactor or chamber thereof. The in-line continuous flow chemical reactor may be a recycle loop reactor or a single pass reactor. In one embodiment, the in-line continuous flow chemical reactor is a single pass reactor.

The static mixer scaffold may be configured for enhancing mixing and heat transfer characteristics for redistributing fluid in directions transverse to the main flow, for example in radial and tangential or azimuthal directions relative to a central longitudinal axis of the static mixer scaffold. The static mixer scaffold may be configured for at least one of (i) to ensure as much catalytic surface area as possible is presented to the flow so as to activate close to a maximum number of reaction sites and (ii) to improve flow mixing so that (a) the reactant molecules contact surfaces of the static mixer scaffold more frequently and (b) heat is transferred away from or to the fluid efficiently. The static mixer scaffold may be provided with various geometric configurations or aspect ratios for correlation with particular applications. The static mixer scaffolds enable fluidic reactants to be mixed and brought into close proximity with the catalytic material for activation. The static mixer scaffold may be configured for use with turbulent flow rates, for example enhancing turbulence and mixing, even at or near the internal surface of the reactor chamber housing. It will also be appreciated that the static mixer scaffold can be configured to enhance the heat and mass transfer characteristics for both laminar and turbulent flows.

The configurations may also be designed to enhance efficiency, degree of chemical reaction, or other properties such as pressure drop (whilst retaining predetermined or desired flow rates), residence time distribution or heat transfer coefficients. As previously mentioned, traditional static mixers have not been previously developed to specifically address enhanced heat transfer requirements, which may result from the catalytic reaction environments provided by the present static mixers.

The configuration of the scaffold, or static mixer, may be determined using Computational Fluid Dynamics (CFD) software, which can be used for enhancing the configuration for mixing of reactants for enhanced contact and activation of the reactants, or reactive intermediates thereof, at the catalytically reactive sites of the scaffold. The CFD based configuration determinations are described in further detail in sections below.

The static mixer scaffold may be formed by additive manufacturing. The static mixer may be an additive manufactured static mixer. Additive manufacturing of the static mixer and subsequent catalytically reactive sites on the surface of the scaffold can provide a static mixer that is configured for efficient mixing, heat transfer and catalytic reaction (of reactants in continuous flow chemical reactors), and in which the static mixer may be physically tested for reliability and performance, and optionally further re-designed and re-configured using additive manufacturing (e.g. 3D printing) technology. Additive manufacturing provides flexibility in preliminary design and testing, and further re-design and re-configuration of the static mixers to facilitate development of more commercially viable and durable static mixers.

The static mixer scaffold may be provided in a configuration selected from one or more of the following general non-limiting example configurations:
open configurations with helices;
open configurations with blades;
corrugated-plates;
multilayer designs;
closed configurations with channels or holes.

The scaffold of the static mixer may be provided in a mesh configuration having a plurality of integral units defining a plurality of passages configured for facilitating mixing of the one or more fluidic reactants.

The static mixer scaffold may comprise a scaffold provided by a lattice of interconnected segments configured to define a plurality of pores for promoting mixing of fluid flowing through the reactor chamber. The scaffold may also be configured to promote both heat transfer as well as fluid mixing.

In various embodiments, the geometry or configuration may be chosen to enhance one or more characteristics of the static mixer scaffold selected from: the specific surface area, volume displacement ratio, strength and stability for high flow rates, suitability for fabrication using additive manufacturing, and to achieve one or more of: a high degree of chaotic advection, turbulent mixing, catalytic interactions, and heat transfer.

In some embodiments, the static mixer scaffold may be configured to enhance chaotic advection or turbulent mixing, for example cross-sectional, transverse (to the flow) or localised turbulent mixing. The geometry of the static mixer scaffold may be configured to change the localised flow direction or to split the flow more than a certain number of times within a given length along a longitudinal axis of the static mixer scaffold, such as more than 200 m⁻¹, optionally more than 400 m⁻¹, optionally more than 800 m⁻¹, optionally more than 1500 m⁻¹, optionally more than 2000 m⁻¹, optionally more than 2500 m⁻¹, optionally more than 3000 m⁻¹, optionally more than 5000 m⁻¹. The geometry or configuration of the static mixer scaffold may comprise more than a certain number of flow splitting structures within a given volume of the static mixer, such as more than 100 m⁻³, optionally more than 1000 m⁻³, optionally more than 1×10⁴ m⁻³, optionally more than 1×10⁶ m⁻³, optionally more than 1×10⁹ m⁻³, optionally more than 1×10¹⁰ m⁻³.

The geometry or configuration of the static mixer scaffold may be substantially tubular or rectilinear. The static mixer scaffold may be formed from or comprise a plurality of segments. Some or all of the segments may be straight segments. Some or all of the segments may comprise polygonal prisms such as rectangular prisms, for example. The static mixer scaffold may comprise a plurality of planar surfaces. The straight segments may be angled relative to each other. Straight segments may be arranged at a number of different angles relative to a longitudinal axis of the scaffold, such as two, three, four, five or six different angles, for example. The static mixer scaffold may comprise a repeated structure. The static mixer scaffold may comprise a plurality of similar structures repeated periodically along the longitudinal axis of the scaffold. The geometry or configuration of the static mixer scaffold may be consistent along the length of the scaffold. The geometry of the static mixer scaffold may vary along the length of the static mixer scaffold. The straight segments may be connected by one or more curved segments. The scaffold may comprise one or more helical segments. The static mixer scaffold may generally define a helicoid. The static mixer scaffold may comprise a helicoid including a plurality of pores in a surface of the helicoid.

The dimensions of the static mixer may be varied depending on the application. The static mixer, or reactor comprising the static mixer, may be tubular. The static mixer or reactor tube may, for example, have a diameter (in mm) in the range of 1 to 5000, 2 to 2500, 3 to 1000, 4 to 500, 5 to 150, or 10 to 100. The static mixer or reactor tube may, for example, have a diameter (in mm) of at least about 1, 5, 10, 25, 50, 75, 100, 250, 500, or 1000. The static mixer or reactor tube may, for example, have a diameter (in mm) of less than about 5000, 2500, 1000, 750, 500, 250, 200, 150, 100, 75, or 50. The aspect ratios (L/d) of the static mixer scaffolds, or reactor chambers comprising the static mixer scaffolds, may be provided in a range suitable for industrial scale flow rates for a particular reaction. The aspect ratios may, for example, be in the range of about 1 to 1000, 2 to 750, 3 to 500, 4 to 250, 5 to 100, or 10 to 50. The aspect ratios may, for example, be less than about 1000, 750, 500, 250, 200, 150, 100, 75, 50, 25, 20, 15, 10, 9, 8, 7, 6, 5, 4, 3, or 2. The aspect ratios may, for example, be greater than about 1, 2, 3, 4, 5, 6, 7, 8, 9, 10, 15, 20, 25, 50, 75, or 100. It will be appreciated that the aspect ratio means the ratio of length to diameter (L/d) of a single unit or scaffold.

The static mixer scaffold or reactor is generally provided with a high specific surface area (i.e., the ratio between the internal surface area and the volume of the static mixer scaffold and reactor chamber). The specific surface area may be lower than that provided by a packed bed reactor system. The specific surface area (m² m⁻³) may be in the range of 100 to 40,000, 200 to 30,000, 300 to 20,000, 500 to 15,000, or 12000 to 10,000. The specific surface area (m² m⁻³) may be at least 100, 200, 300, 400, 500, 750, 1000, 2000, 3000, 4000, 5000, 7500, 10000, 12500, 15000, 17500, or 20000. It will be appreciated that the specific surface areas can be measured by a number of techniques including the BET isotherm techniques.

The static mixer scaffolds may be configured for enhancing properties, such as mixing and heat transfer, for laminar flow rates or turbulent flow rates. It will be appreciated that for Newtonian fluids flowing in a hollow pipe, the correlation of laminar and turbulent flows with Reynolds number (Re) values would typically provide laminar flow rates where Re is <2300, transient where 2300<Re<4000, and generally turbulent where Re is >4000. The static mixer scaffolds may be configured for laminar or turbulent flow rates to provide enhanced properties selected from one or more of mixing, degree of reaction, heat transfer, and pressure drop. It will be appreciated that further enhancing a particular type of chemical reaction will require its own specific considerations.

The static mixer scaffold may be generally configured for operating at a Re of at least 0.01, 0.1, 1, 5, 50, 100, 150, 200, 250, 300, 350, 400, 550, 600, 650, 700, 750, 800, 850, 900, 950, 1000, 1100, 1200, 1300, 1400, 1500, 1600, 1700, 1800, 1900, 2000, 2500, 3000, 3500, 4000, 4500, 5000, 5500, 6000, 6500, 7000, 7500, 8000, 8500, 9000, 9500, 10000. The static mixer scaffold may be configured for operating in a generally laminar flow Re range of about 0.1 to 2000, 1 to 1000, 10 to 800, or 20 to 500. The static mixer scaffold may be configured for operating in a generally turbulent flow Re ranges of about 1000 to 15000, 1500 to 10000, 2000 to 8000, or 2500 to 6000.

The volume displacement % of the static mixer relative to a reactor chamber for containing the mixer is in the range of 1 to 40, 2 to 35, 3 to 30, 4 to 25, 5 to 20, or 10 to 15. The volume displacement % of the static mixer relative to a reactor chamber for containing the mixer may be less than 40%, 35%, 30%, 25%, 20%, 15%, 10%, or 5%.

The configurations of the static mixers may be provided to enhance cross-sectional microscopic turbulence. Such turbulence may result from various sources, including the geometry of CSM or the microscopic roughness of the CSM surface resulting from the 3D printing process and/or surface coating. For example, turbulent length scales may be reduced to provide better mixing. The turbulent length scales may, for example, be in the range of microscopic length scales.

The configurations of the static mixers may be provided to enhance heat transfer properties in the reactor, for example a reduced temperature differential at the exit cross-section. The heat transfer of the CSM may, for example, provide a cross-sectional or transverse temperature profile that has a temperature differential of less than about 20° C./mm, 15° C./mm, 10° C./mm, 9° C./mm, 8° C./mm, 7° C./mm, 6° C./mm, 5° C./mm, 4° C./mm, 3° C./mm, 2° C./mm, or 1° C./mm.

The scaffold may be configured such that, in use, the pressure drop (i.e. pressure differential or back pressure) across the static mixers (in Pa/m) is in a range of about 0.1 to 1,000,000 Pa/m (or 1 MPa/m), including at any value or range of any values therebetween. For example, the pressure drop across the static mixer (in Pa/m) may be less than about 500,000, 250,000, 100,000, 50,000, 10,000, 5,000, 1,000, 750, 500, 250, 100, 75, 50, 25, 20, 15, 10, or 5 Pa/m. The static mixers may be configured to provide a lower pressure drop relative to a specific flow rate. In this regard, the static mixers, reactor, system, and processes, as described herein, may be provided with parameters suitable for industrial application. The above pressure drops may be maintained where the volumetric flow rate is at least 0.1, 0.5, 1, 1.5, 2, 2.5, 3, 3.5, 4, 4.5, 5, 6, 7, 8, 9, 10, 20, 30, 40, 50 ml/min.

### Process for Preparing Static Mixer

The static mixer scaffold may be provided by additive manufacturing, such as 3D printing. Additive manufacturing of the static mixer and subsequent catalytically reactive sites on the surface of the scaffold can provide a static mixer that is configured for efficient mixing, heat transfer and catalytic reaction (of reactants in continuous flow chemical reactors), and in which the static mixer may be physically tested for reliability and performance, and optionally further re-designed and re-configured using additive manufacturing (e.g. 3D printing) technology. Following original design and development using additive manufacturing, the static mixer may be prepared using other manufacturing process, such as casting (e.g. investment casting). The additive manufacturing provides flexibility in preliminary design and testing, and further re-design and re-configuration of the static mixers to facilitate development of more commercially viable and durable static mixers.

The static mixer scaffolds may be made by the additive manufacture (i.e. 3D printing) techniques. For example, an electron beam 3D printer or a laser beam 3D printer may be used. The additive material for the 3D printing may be, for example, titanium alloy based powders (e.g. 45-105 micrometre diameter range) or the cobalt-chrome alloy based powders (e.g. FSX-414) or stainless steel or aluminium-silicon alloy or titanium-based alloys or nickel-based alloys or palladium-based alloys or platinum-based alloys or nickel-aluminium based alloys or ruthenium-based alloys or rhodium-based alloys. In one embodiment the additive material for the 3D printing may be nickel-based alloys, palladium-based alloys or nickel-aluminium based alloys. The powder diameters associated with the laser beam printers are typically lower than those used with electron beam printers.

3D printing is well understood and refers to processes that sequentially deposit material onto a powder bed via fusion facilitated by the heat supplied by a beam, or by extrusion and sintering-based processes. 3D printable models are typically created with a computer aided design (CAD) package. Before printing a 3D model from an STL file, it is typically examined for manifold errors and corrections applied. Once that is done, the .STL file is processed by software called a “slicer,” which converts the model into a series of thin layers and produces a G-code file containing instructions tailored to a specific type of 3D printer. The 3D printing process is advantageous for use in preparing the static mixer scaffolds since it eliminates the restrictions to product design imposed by traditional manufacturing routes. Consequently, the design freedom inherited from 3D printing allows a static mixer geometry to be further optimised for performance than it otherwise would have been.

The catalytically active scaffold may be prepared by chemically removing sacrificial material from the surface of the scaffold material to provide catalytically reactive sites on the surface of the scaffold.

In some embodiments, the process may first comprise forming the scaffold using an additive manufacturing process, such as 3D printing.

### EXAMPLES

The present disclosure is further described by the following examples. It is to be understood that the following description is for the purpose of describing particular embodiments only and is not intended to be limiting with respect to the above description.

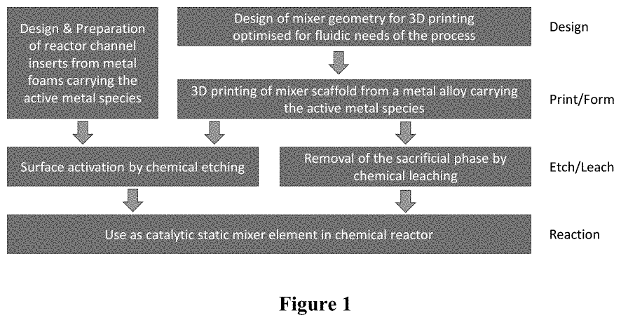

The present disclosure provides an effective and scalable process for preparing a catalytically active scaffold or catalytically active static mixer scaffold by activating a surface of a scaffold by chemically removing sacrificial and/or active material from the surface of the scaffold to provide catalytically reactive sites on the surface of the scaffold or static mixer scaffold. Referring to FIG. 1, the process may include a selective chemical process or a non-selective chemical process. The selective chemical process may be a chemical leaching process for removing sacrificial material, and the non-selective chemical process may be a chemical etching process for removing sacrificial material and/or active material. The chemical process used may be dependent on the type of scaffold or static mixer scaffold.

### Example 1: General Process for Preparing Catalytically Active Scaffolds from 3D Printed Scaffolds Using the Leaching Method

The static mixer scaffold was printed from metal or metal oxide powder and then subjected to one or more leaching solutions containing ammonium sulfate or ammonium persulfate.

Ni-based catalytic static mixers were prepared from Monel (alloy 400) powder according to the general process described above, with a composition of ˜61% Ni, 35% Cu, 2.2% Fe, 1.3% Mn and 0.5% Si. This process selectively removes copper from the scaffold, enriching the surface of the scaffold with nickel, and forming a catalytically active static mixer scaffold.

The Ni/Cu ratio at the surface of the catalytically active static mixer was between 4 and 8 after the chemical leaching treatment, compared to 1.77 in the untreated samples.

It will be appreciated that after an activation process, the Ni-based catalytically active static mixer scaffold may be used as a Ni[0] type catalyst for catalytic reactions, for example, hydrogenation reactions.

### Example 1a Ni-Based CSM Prepared from Monel 400 by Chemical Leaching

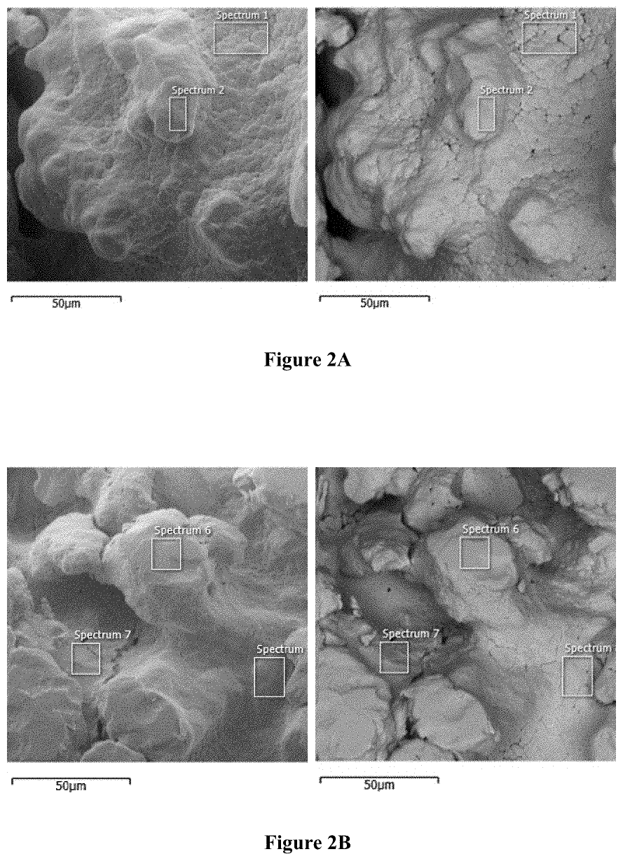

In an example, a Monel static mixer scaffold was added to 450 mL of an aqueous solution of [2M] ammonium sulphate and [5M] ammonia, left for 10 days and sonicated for at least 1 hour per day. Ca. 30 mL of aqueous ammonia was added once every three days to replace ammonia lost as gas. The mixture was observed to turn a pale green. The mixer was then washed in water and added to a separate 450 mL aqueous solution of [2M] ammonium persulfate and [5M] ammonia, and the same protocol applied with the mixer being left for 12 days. The mixture was observed to turn a sapphire blue, the colour of [Cu(NH₃)(OH₂)₂]²⁺. The catalytically active static mixer scaffold was then washed. As shown by the SEM images (FIG. 2), there are visible differences between the untreated (FIG. 2a) and treated (FIG. 2b) Monel static mixers. For example, the surface area of the Monel static mixer is at least about 30% greater when compared to the surface area of the scaffold material without sub-pores.

The mass loss of the Monel static mixer is 5 wt. % when compared to the total mass of the scaffold material without sub-pores.

The pore size of the one or more pores within the pores is approximately 0.1 μm.

XPS results showing the change in Ni:Cu ratio before and after treatment are shown below in Table 1. As can be seen from the XPS results, the selective enrichment of nickel (i.e. active catalyst species) is at least 2 fold compared to copper (i.e. sacrificial material). This is dependent on the leaching agent and leaching time. For example, the selective enrichment of nickel is about 7 fold compared to copper when ammonium persulfate is used as the leaching agent after 7 day leaching time.

TABLE 1
Ni:Cu ratio before and after treatment of Monel with
various chemical leaching solutions

| | | leaching | Ni:Cu |
|---|---|---|---|
| leaching agent | [NH₃] | time | ratio |
| [1M] ammonium persulfate | [7M] | 7 days | 7.8:1 |
| [0.2M] ammonium persulfate | [5M] | 7 days | 6.5:1 |
| [0.5M] ammonium persulfate | [5M] | 3 days | 5.8:1 |
| [0.5M] ammonium persulfate | [7M] | 7 days | 5.1:1 |
| [1M] ammonium sulfate | [7M] | 7 days | 4.2:1 |
| none (pure Monel) | N/A | N/A | 1.8:1 |

### Example 2: General Process Form Preparing Catalytically Active Scaffolds from 3D Printed Scaffolds Using the Etching Method

The static mixer scaffold was printed from Inconel powder having a composition of ˜61% Ni, 16% Cr, 8.5% Co, 3.4% Al, 3.4% Ti, 2.6% W, 1.8% Ta, 1.8% Mo, and smaller amounts of Fe, C, B, Zr, Mn, Si and S. The static mixer scaffold was then subjected to a chemical etching solution: Marble's reagent, [1M] copper sulphate in [4.4M] aqueous hydrochloric acid. The chemical etching process provides a surface of the static mixer scaffold that has increased porosity and surface area by providing a non-selective surface etching and oxidation process of metal species, in particular Ni, Cr and other metal species within the alloy material, and thereby forming a chemically active static mixer scaffold.

It will be appreciated that after an additional reduction/activation procedure, to reduce Ni-oxides to Ni[0], the catalytically active static mixer scaffold may be used as a Ni[0] type catalyst for hydrogenation reactions.

### Example 2a Ni-Based CSM Prepared from Inconel 738 by Chemical Etching

In an example, an Inconel static mixer scaffold was prepared according to the general procedure described above, in which the static mixer scaffold was submerged in 250 mL of Marble's reagent ([1M] copper sulphate in [4.4M] aqueous hydrochloric acid) to which 10 drops of pure sulphuric acid was added. The mixer was left for 24 hours, and the solution was observed to turn an opaque black. The mixer was then removed and washed profusely in water.

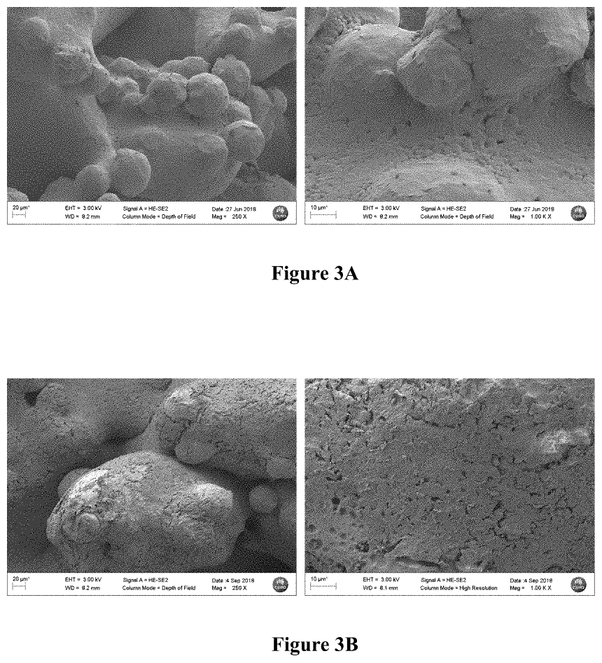

As shown by the SEM images (FIG. 3), there are visible differences between the untreated (FIG. 3a) and treated (FIG. 3b) Inconel static mixers. For example, the surface area of the Inconel static mixer is at least about 30% greater when compared to the surface area of the scaffold material without sub-pores.

The mass loss of the Inconel static mixer is 5 wt. % when compared to the total mass of the scaffold material without sub-pores.

The pore size of the one or more pores within the pores is approximately 0.1 μm.

### Example 3 General Process Form Preparing Catalytically Active Scaffolds from Metal Foam Scaffolds Using the Etching Method

A nickel foam was subject to one or more etching solutions containing hydrochloric acid, nitric acid, ferric chloride, or marble's reagent. This process removes a portion of nickel from the foam, enriching the surface of the foam, and forming a catalytically active static mixer scaffold.

It will be appreciated that after an activation process, the Ni-based catalytically active static mixer scaffold may be used as a Ni[0] type catalyst for catalytic reactions, for example in hydrogenation reactions.

### Example 3a Ni-Based CSM Prepared from Nickel Foam by Chemical Etching

In an example, a Nickel foam was prepared according to the general procedure described above in Example 3, in which the Nickel foam static mixer was submerged in 30 mL of 30 wt % ferric chloride for 1 minute. The mixer was then removed and washed profusely with water.

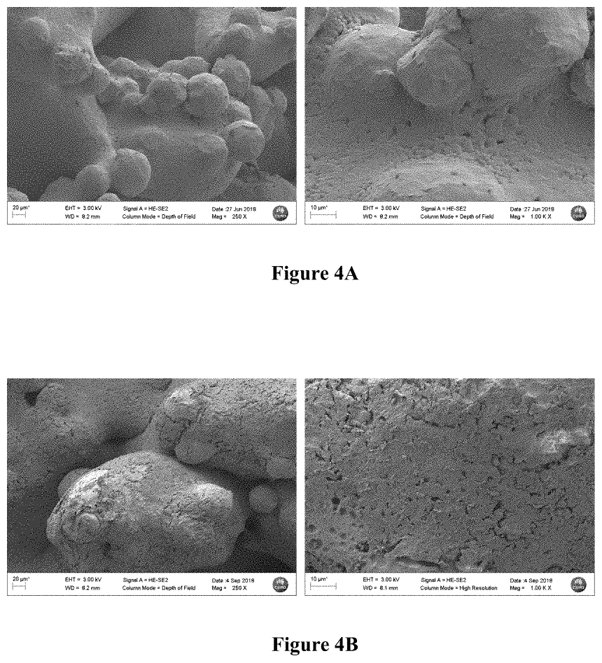

As shown by the SEM images (FIG. 4), there are visible differences between the untreated (FIG. 4a) and treated (FIG. 4b) Nickel foam static mixers. For example, the surface area of the Nickel foam static mixer is at least about 30% greater when compared to the surface area of the scaffold material without sub-pores.

The mass loss of the Nickel foam static mixer is 50 wt. % when compared to the total mass of the scaffold material without sub-pores.

The pore size of the one or more pores within the pores is approximately 0.1 μm.

### Example 4 Catalytically Active Static Mixer Scaffold Preparation Method

Catalytically active static mixer scaffolds were prepared according to the general procedures described above and tested for a range of hydrogenation reactions. The CSMs were printed to the mixer design disclosed in previous work (see WO 2017106916), with an outer diameter of 6 mm and a length of 150 mm. The CSM volumes V_{CSM} and according remaining reactor volume VR were calculated using the displacement of water in a length of standard glass tubing.

TABLE 2
Metal loading, catalyst description and reaction volume for the
following CSMs: Inconel 738, Monel 400, Ni foam
(and for comparison only, wash coated Ni/Al₂O₃)

| Scaffold | | | | | Metal | Reaction |
|---|---|---|---|---|---|---|
| (printed | Coating | Catalytic | | no. | loading | volume |
| or foam) | method | metal | Support | CSMs | (mmol) | (mL) |
| Inconel | etch | Ni | none | 4 | 308 | 13.29 |
| 738 | treatment | | | | | |
| Monel | leach | Ni | none | 4 | 326 | 12.32 |
| 400 | treatment | | | | | |
| Ni foam | etch | Ni | none | 4 | 95.1 | 15.95 |
| | treatment | | | | | |
| stainless | wash-coat | Ni | γ-Al₂O₃ | 4 | 1.81 | 12.01 |
| steel 316L | | | | | | |

### Example 5 Catalyst Activation

Each set of CSMs was activated using hydrogen after being stored in air. The activation process reduces the catalytically deactivating metal oxides formed by aerobic passivation. To identify the necessary conditions, temperature-programmed reduction (TPR) was performed on small cut-offs of the CSMs. The process involves passing a constant stream of 95% N₂/5% H₂ over the catalyst in a furnace, with a steady temperature ramp from 20° C. to 800° C. and recording drops in the thermal conductivity of the gaseous mixture. The protocol for activating each CSM is detailed in Table below.

TABLE 3
Activation protocols for each set of CSMs

| | P | T | | V_{L} | | V_{G,N} | |
|---|---|---|---|---|---|---|---|
| CSM | (bar) | (° C.) | solvent | (mL/min) | gas | (mL_{N}/min) | t(h) |
| Inconel | 24 | 200 | EtOH | 0.05 | H₂ | 100 | 24 |
| etched | | | | | | | |
| Monel | 24 | 200 | EtOH | 0.05 | H₂ | 100 | 24 |
| leached | | | | | | | |
| Ni foam | 24 | 200 | none | 0 | H₂ | 200 | 6 |
| Ni/Al₂O₃ | 1 | 800 | none | 0 | 95% N₂, | 20 | 8* |
| | | | | | 5% H₂ | | |

*Reduction time per CSM.

### Example 6 Performance Evaluation

### Hydrogenation of Vinyl Acetate to Ethyl Acetate:

Vinyl acetate hydrogenation reactions (scheme 1) were carried out in the Mark II hydrogenation reactor, which was loaded with the active CSMs and eight blanks for each experiment (for detailed reactor description and reaction protocol see WO 2017106916 and Hornung et al., Org. Process Res. Dev. 2017, 21, 9, 1311-1319). The CSMs were conditioned prior to each reaction according to the condition parameters. Multiple product fractions were collected, from which the steady state could be determined. Conversion and selectivity data were calculated using ¹H NMR spectra and GC-MS.

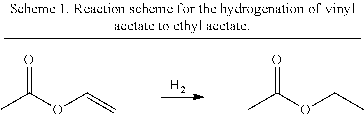

The input variables were pressure, temperature, liquid residence time and H/S ratio. Unless otherwise stated, all reactions were carried out at p=24 bar and T=120° C., and substrates used as [0.5M] solutions in ethyl acetate. All solvents were obtained from Merck.

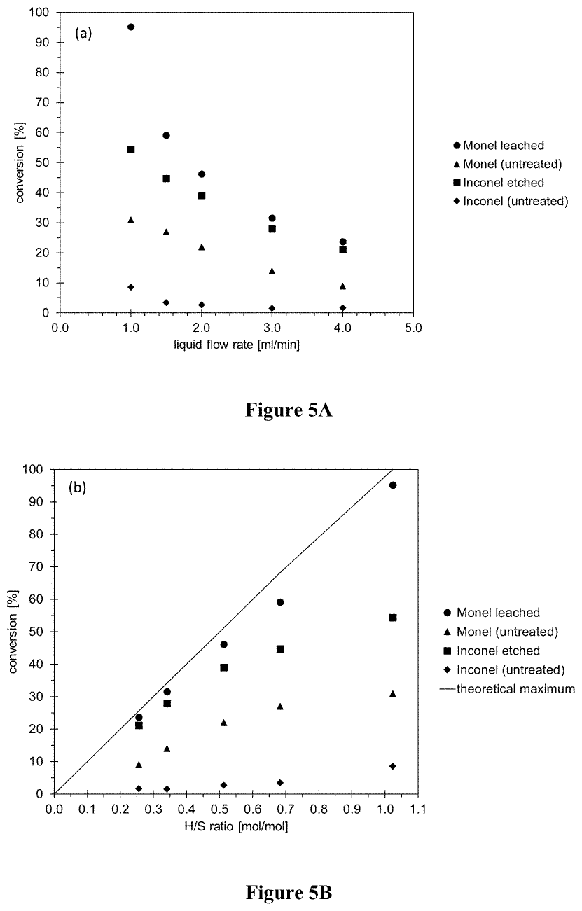

FIGS. 5a and 5b show conversion results at 2M vinyl acetate for the leached Monel CSMs and etched Inconel CSMs; they exhibit excellent performance in comparison to the untreated Inconel CSMs and Monel CSMs. The treated Monel CSMs gave 95% conversion at 1 ml/min vs 30% conversion for the untreated sample and the treated Inconel CSMs gave 55% conversion vs 8% for the untreated sample at the same flow rate. FIG. 5c shows conversion results at 0.5M vinyl acetate for etched nickel foam samples, also showing much improved activity when compared to the untreated samples. The treated nickel foam CSMs gave 88% conversion at 2 ml/min vs 47% conversion for the untreated sample. This demonstrates the efficiency of the chemical etching and leaching processes to create catalysts with high surface area and therefore catalytic activity. Advantageously, the leached and etched CSMs improve performance as the hydrogen availability (H/S) and residence time increased (i.e. with decreasing liquid flow rates).

### Hydrogenation of Coumarin:

The performance of the leached Monel CSMs was also tested for the hydrogenation of coumarin (see Scheme 2).

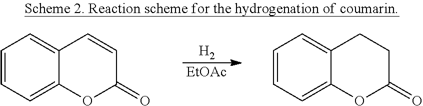 [SMILES: "EtOAc" ; O=c1ccc2ccccc2o1 ; "H2" ; O=C1CCc2ccccc2O1]

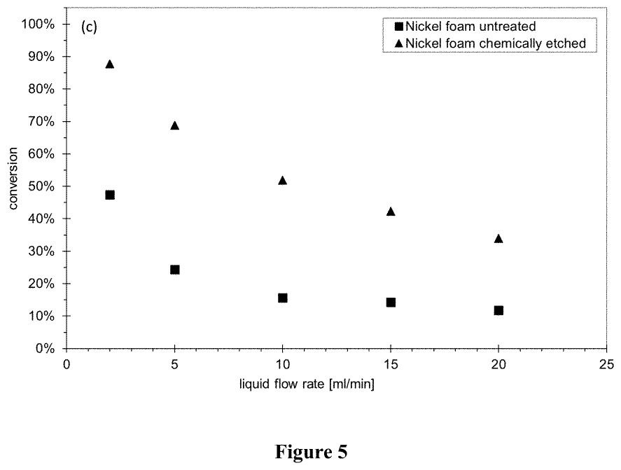

As can be seen in FIG. 6, the leached Monel CSMs performed well with high conversions. Coumarin conversions were higher at longer residence times and lower liquid flow rates, as expected.

Hydrogenation of Cinnamaldehyde, Linalool and 2,5-dichloronitrobenzene

Further test reactions were undertaken to compare the selectivity of the leached Monel CSMs. The hydrogenation of cinnamaldehyde, linalool, and 2,5-dichloronitrobenzene is depicted in schemes 3, 4, and 5 below:

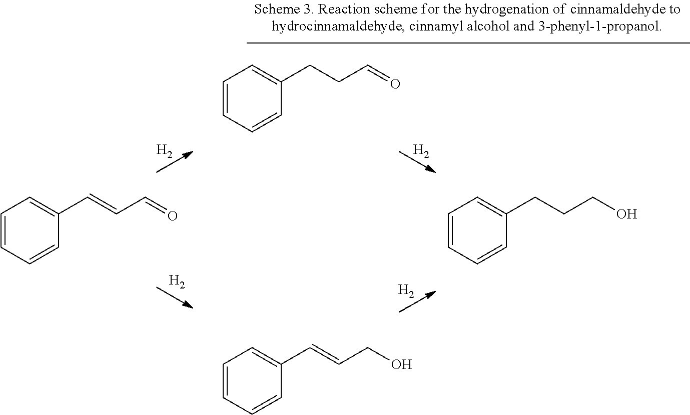

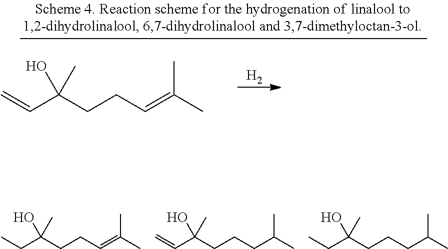

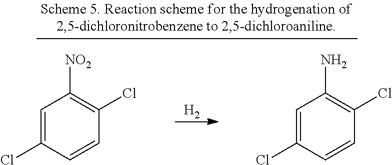 [SMILES: O=[N+]([O-])c1cc(Cl)ccc1Cl ; "H2" ; Nc1cc(Cl)ccc1Cl]

In the above cases in schemes 3 and 4, selectivity towards three possible hydrogenation products (two semi-hydrogenated intermediate species and one fully-hydrogenated species) has to be considered, as the substrates both have two reactive moieties that can be reduced; in the case of cinnamaldehyde, these are a C—C double bond and a carbonyl group; in the case of linalool, they are a terminal C—C double bond and an internal C—C double bond.

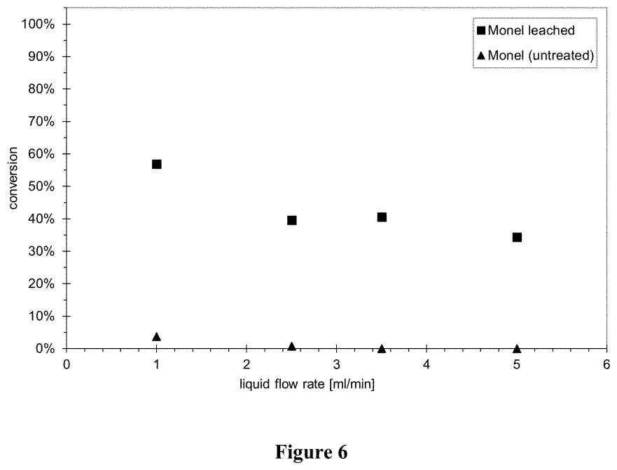

FIG. 7 shows that leached Monel CSMs hydrogenated mainly the C—C double bond, resulting in the hydro cinnamaldehyde intermediate as the major product, followed by smaller amounts of the fully hydrogenated 3-phenyl-1-propanol and other unidentified side products. No cinnamyl alcohol was produced.

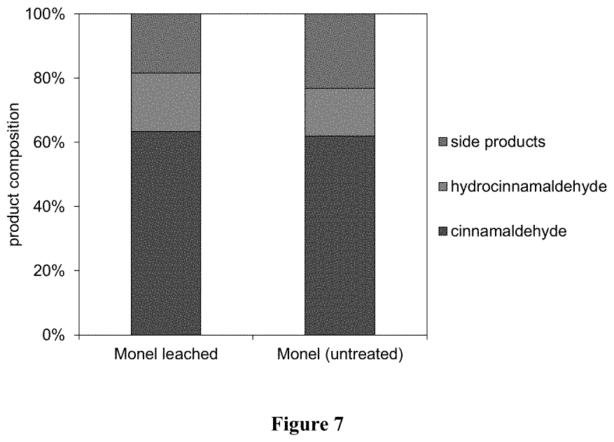

For the reduction of linalool (FIG. 8) surprising selectivity was observed when using the leached Monel catalyst. For Ni/Al₂O₃ as well as for other Ni, Pd or Ru type catalysts that we tested, a strong selectivity towards the reduction of either one of the two C—C double bonds was not observed, while the leached Monel catalyst reduced the terminal C—C double bond, producing 1,2-dihydrolinalool and no 6,7-dihydrolinalool or 3,7-dimethyloctan-3-ol (with small amounts of unreacted starting material remaining). This 100% selectivity towards the reduction of a terminal double bond was an unexpected advantageous effect and considered to be a result of the alloy type and nature of the prepared catalyst of the present disclosure, which contains Cu and other metal species within a Ni-rich matrix.

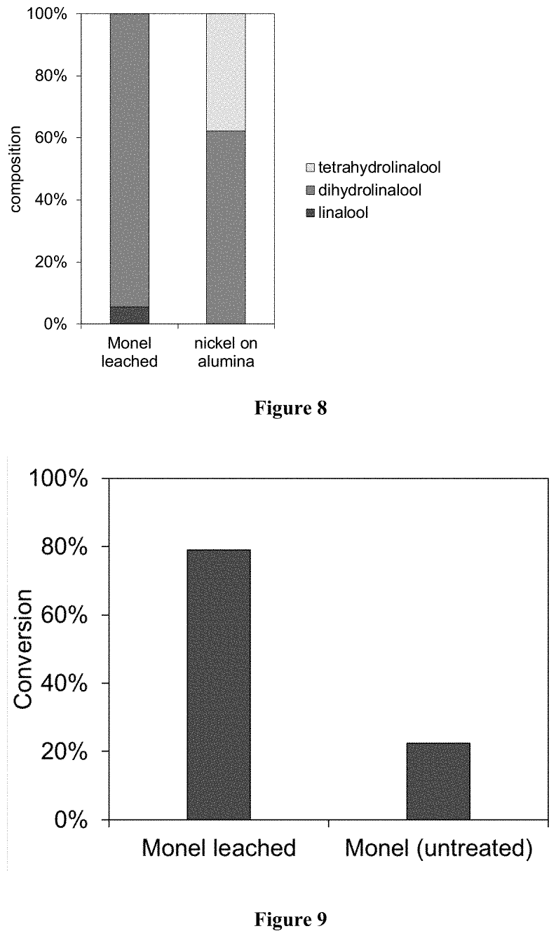

FIG. 9 shows conversion for the hydrogenation of 2,5-dichloronitrobenzene to 2,5-dichloroaniline over leached Monel CSMs and untreated Monel CSMs. Again, the treated samples performed significantly better with a conversion of 80% vs 24% for the untreated CSMs.

1. A catalytically active static mixer comprising a scaffold material comprising an active catalyst material, and optional an inert material;
wherein the scaffold material is in the form of a lattice of interconnected segments repeated periodically along the longitudinal axis of the scaffold, each segment configured to define a plurality of passages and pores in a non-line-of-sight configuration, wherein the plurality of passages are configured for dispersing and mixing one or more fluidic reactants during flow and reaction thereof, by redistributing the fluid in directions transverse to the flow by changing the localised flow direction or to splitting the flow by more than 200 m⁻¹, corresponding to a number of times within a given length along a longitudinal axis of the catalytically active static mixer;
wherein the plurality of passages is defined by a plurality of pores;
wherein the pores comprises one or more sub pores within the pores; and
wherein the pores are at least about 100 fold larger than the sub pores.

2. The catalytically active static mixer of claim 1, wherein the mass of the catalytically active static mixer is in a range between about 0.5 wt. % and 60 wt. % less when compared to the total mass of the scaffold material without sub-pores.

3. The catalytically active static mixer of claim 1 or claim 2, wherein the surface area of the catalytically active static mixer is at least about 30% greater when compared to the surface area of the scaffold material without sub-pores.

4. The catalytically active static mixer of any one of the preceding claims, wherein the active catalyst material is selected from the group comprising palladium, platinum, nickel, ruthenium, copper, rhodium, gold, silver, cobalt, iridium, osmium, rhenium, chromium, or mixed metal alloys or metal oxides thereof, zeolites, and metal organic frameworks.

5. The catalytically active static mixer of any one of the preceding claims, wherein the pore size of the one or more pores within the pores is in a range of about 0.05 μm to 500 μm.

6. The catalytically active static mixer of any one of the preceding claims, wherein the inert material is selected from the group comprising magnesium, or metal oxides thereof, silicon, silicone, polymers, ceramics, and metal oxides.

7. The catalytically active static mixer of any one of the preceding claims, wherein the scaffold material is one or more of nickel, titanium, aluminium, tungsten, niobium, molybdenum, steel, stainless steel, copper, cobalt chrome, titanium-based alloys, nickel-based alloys, palladium-based alloys, nickel-aluminium based alloys, platinum-based alloys, ruthenium-based alloys, rhodium-based alloys, gold, platinum, palladium and silver.

8. The catalytically active static mixer of any one of the preceding claims, wherein the surface area of the catalytically active scaffold is in a range of about 0.5 m²/g to 750 m²/g.

9. The catalytically active static mixer of any one of the preceding claims, wherein the total pore volume of the catalytically active scaffold is in a range of about 0.2 cm³/g to 10 cm³/g.

10. The catalytically active static mixer of any one of the preceding claims, wherein the aspect ratio (L/d) of the catalytically active static mixer is at least 75.

11. A process for preparing a catalytically active static mixer from a scaffold material which is in the form of a lattice of interconnected segments repeated periodically along the longitudinal axis of the scaffold, each segment configured to define a plurality of passages and pores in a non-line-of-sight configuration, wherein the plurality of passages are configured for dispersing and mixing one or more fluidic reactants during flow and reaction thereof, by redistributing the fluid in directions transverse to the flow by changing the localised flow direction or to splitting the flow by more than 200 m⁻¹, corresponding to a number of times within a given length along a longitudinal axis of the static mixer, wherein the plurality of passages is defined by a plurality of pores, wherein the scaffold material comprises an active catalyst material and a non-active material, wherein the process comprises the step of: (i) activating a surface of a scaffold material by chemically removing at least about 0.5 wt. % of non-active material from the surface of the scaffold material to provide the catalytically active static mixer with catalytically reactive sites on the scaffold material and catalytically active sub pores within the pores of the scaffold material, wherein the scaffold material is activated using a selective or non-selective chemical process.

12. The process of claim 11, wherein the scaffold material further comprises an inert material.

13. The process of claim 11 or claim 12, wherein the selective chemical process is chemical leaching for removing at least about 0.5 wt. % of sacrificial material from the scaffold material, wherein the sacrificial material is the non-active material.

14. The process of claim 11 or claim 13, wherein the non-selective chemical process is chemical etching for removing at least about 0.5 wt. % of sacrificial material from the scaffold material, wherein the sacrificial material is the active catalyst material, the non-active material, the optional inert material, or a combination thereof.

15. The process of claim 14, wherein the chemical etching process comprises use of an etching solution.

16. The process of claim 13, wherein the chemical leaching process comprises use of a leaching solution.

17. The process of any one of claims 11 to 16, wherein the pores are at least about 100 fold larger than the sub pores.

18. The process of any one of claims 11 to 17, wherein the pores are at least about 1000 fold larger than the sub pores.

19. The process of any one of claims 11 to 18, wherein the mass loss of sacrificial material from the catalytically active scaffold is in a range between about 0.5 wt. % and 60 wt. %, based on the total mass of the scaffold material.

20. The process of any one of claims 11 to 19, wherein the active catalyst material is selected from the group comprising palladium, platinum, nickel, ruthenium, copper, rhodium, gold, silver, cobalt, iridium, osmium, rhenium, chromium, or mixed metal alloys or metal oxides thereof, zeolites, and metal organic frameworks.

21. The process of any one of claims 11 to 20, wherein the non-active material is selected from the group comprising chromium, titanium, copper, iron, zinc, aluminium, nickel, silver, or metal oxides thereof, and carbon-based materials.

22. The process of any one of claims 11 to 21, wherein the inert material is selected from the group comprising magnesium, or metal oxides thereof, silicon, silicone, polymers, ceramics, and metal oxides.

23. The process of any one of claims 11 to 22, wherein the scaffold material is one or more of nickel, titanium, aluminium, tungsten, niobium, molybdenum, steel, stainless steel, copper, cobalt chrome, titanium-based alloys, nickel-based alloys, palladium-based alloys, nickel-aluminium based alloys, platinum-based alloys, ruthenium-based alloys, rhodium-based alloys, gold, platinum, palladium and silver.

24. The process of any one of claims 11 to 23, wherein the surface area of the catalytically active static mixer increases by at least about 30% when compared to the surface area of the scaffold material without sub pores.

25. The process of any one of claims 11 to 24, wherein the surface area of the catalytically active scaffold is in a range of about 0.5 m²/g to 750 m²/g.

26. The process of any one of claims 11 to 25, wherein the total pore volume of the catalytically active scaffold is in a range of about 0.2 cm³/g to 10 cm³/g.

27. The process of any one of claims 11 to 26, wherein the pore size of the sub pores is in a range of about 0.05 μm to 500 μm.

28. The process of any one of claims 11 to 27, wherein the aspect ratio (L/d) of the catalytically active static mixer is at least 75.

29. The process of any one of claims 11 to 28, wherein the process comprises step ii) a further activation step for removing metal oxide impurities by contacting the surface of the catalytically active static mixer with hydrogen gas.
